(19) United States
(12) Patent Application Publication
(10) Pub. No.: US 2021/0166524 A1
(43) Pub. Date: Jun. 3, 2021

(54) SYSTEM AND METHOD FOR CONSTRUCTING SLOT MACHINE DATABASE, NETWORK, AND SLOT MACHINE NETWORK TRACKING APPLICATION

(71) Applicant: SLOT KARMA, INC., New Fairfield, CT (US)

(72) Inventors: Jennifer DeRosa, New Fairfield, CT (US); David DeRosa, New Fairfield, CT (US)

(73) Assignee: SLOT KARMA, INC., New Fairfield, CT (US)

(21) Appl. No.: 17/109,535

(22) Filed: Dec. 2, 2020

Related U.S. Application Data
(60) Provisional application No. 62/942,542, filed on Dec. 2, 2019.

(51) Int. Cl. G07F 17/32; G07F 17/34

(52) U.S. Cl. CPC G07F 17/3223; G07F 17/34

(57) ABSTRACT

Embodiments are directed to system, processes, applications and databases for creating, collecting, networking, sharing and tracking slot machine information.

### CROSS REFERENCE TO RELATED APPLICATION

The present application claims priority to U.S. Provisional Patent Application No. 62/942,542 of the same title and filed on Dec. 2, 2019, the entirety of which is incorporated by reference hereby.

### TECHNICAL FIELD

Systems and methods for servers and databases for slot machine tracking and networking.

### BACKGROUND

Current casino slot machine network technology and methods are configured to track slot machine players with cards linked to rewards. Players insert the cards to identify themselves to each casino's highly sophisticated tracking technology and databases. The casinos benefit by tracking users' gambling patterns at macro and micro levels, and are able to employ and adjust machine and network algorithms to keep users engaged with the slot machines.

Slot machine players, however, have no ability to engage the casino's tracking systems to understand slot machine patterns or other player patterns. Moreover, each casino's system is independent to that casino's enterprise. Different casino networks cannot track the same player, but must have their own unique rewards program to track the player.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of an environment in which at least one of the various embodiments can be implemented;

FIG. 2 shows an embodiment of a client computer that can be included in a system such as that shown in FIG. 1;

FIG. 3 shows an embodiment of a network computer that can be included in a system such as that shown in FIG. 1;

FIGS. 4A-4C illustrates logical architectures of a system in accordance with at least one of the various embodiments;

FIG. 5 represents a logical architecture for a system in accordance with at least one of the various embodiments;

FIGS. 6A-6B illustrates an overview flowchart for a process in accordance with at least one of the various embodiments;

FIGS. 7-19 illustrate user interfaces in accordance with at least one of the various embodiments.

### DETAILED DESCRIPTION OF THE EMBODIMENTS

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments can be methods, systems, media, or devices. Accordingly, the various embodiments can take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “widget controller” refers to a computer program that can be operative on a client application. Widget controllers can be downloaded and/or otherwise deployed to a client application. Widget controllers can be arranged to be operative for downloading content, monitoring consumer actions, or otherwise managing widgets located within client applications.

As used herein, the term “widget” refers to a user-interface element located in the client application. Widgets can be invisible or visible to users of the client applications. In some cases, a widget controller can generate widget “on-the-fly” before deploying content into the widget. Widgets can be adapted to reflect the operating environment of the client application that they are being hosted within. For example, in clients that support HTML, CSS a widget can be an HTML element such as a DIV, P, or the like. For client application operative in a Java environment, a widget can be a View object or Window object, and so on.

As used herein, the term “Host” can refer to an individual person, partnership, organization, or corporate entity that can own or operate one or more digital media properties (e.g., web sites, mobile applications, or the like).

The following briefly describes embodiments in order to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to a system and method of generating databases and application interfaces for tracking and networking slot machine data and player data.

Exemplary advantages of the system and applications therefor is to (a) inform users of the application about the recent play history of a particular slot machine (e.g.: total time played, wins and losses; (b) allow users to record and enter in their own personal play time, wins and losses in order to share this data with others; (c) allow users to record and enter in other players' wins at the casino in order to share this data with others (d) and build a database of recent and historical activity on all individual slot machines any casino and across different casinos and casino enterprises.

In an embodiment, users can download a slot machine network tracking (SMNT) application to their mobile device which gives the users of the SMNT application the unique ability to easily record their play time and payout. In addition, this SMNT application gives the users of the SMNT application the ability to search and research any machine in any casino in the database so they are able to see recent activity on any particular machine.

Users create an account and a profile within the SMNT application. In an embodiment, the system can be configured to include a social networking architecture so that users can link and communicate with each other and follow specific slot machines and casinos. Chat functionality can also be built into or integrated with the SMNT application.

### Illustrative Operating Environment

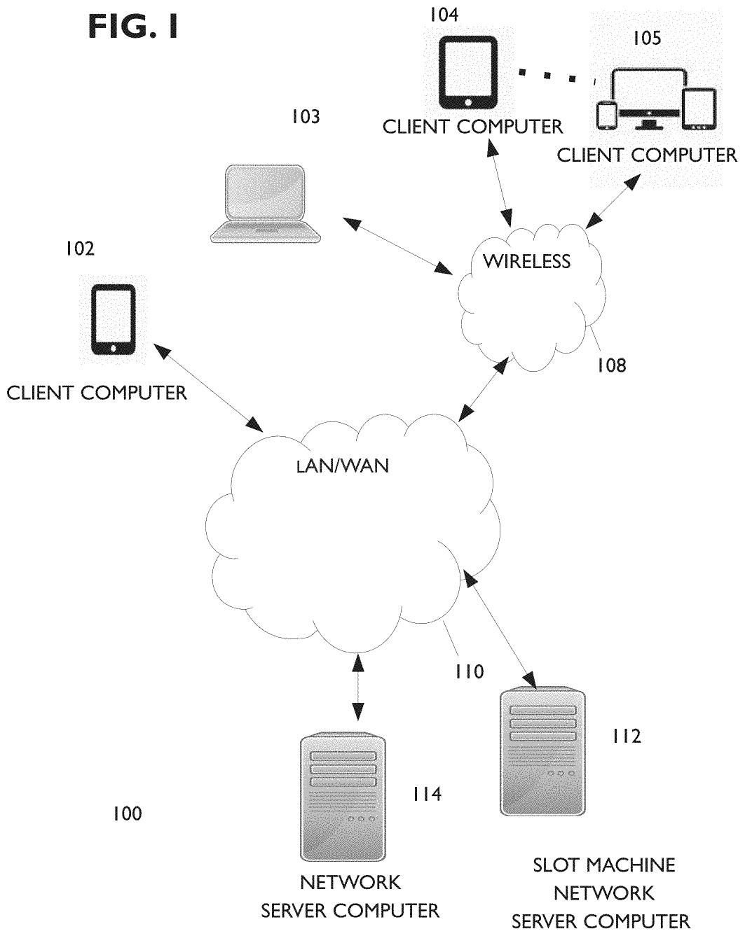

FIG. 1 shows components of one embodiment of an environment in which embodiments of the innovations described herein can be practiced. Not all of the components may be required to practice the innovations, and variations in the arrangement and type of the components can be made without departing from the spirit or scope of the innovations. As shown, system 100 of FIG. 1 includes local area networks (LANs)/wide area networks (WANs)—(network) 110, wireless network 108, client computers 102-105, Slot Machine Network Server Computer (SMNSC) 112, and Network Server Computer 114 (e.g. other computer services or networks).

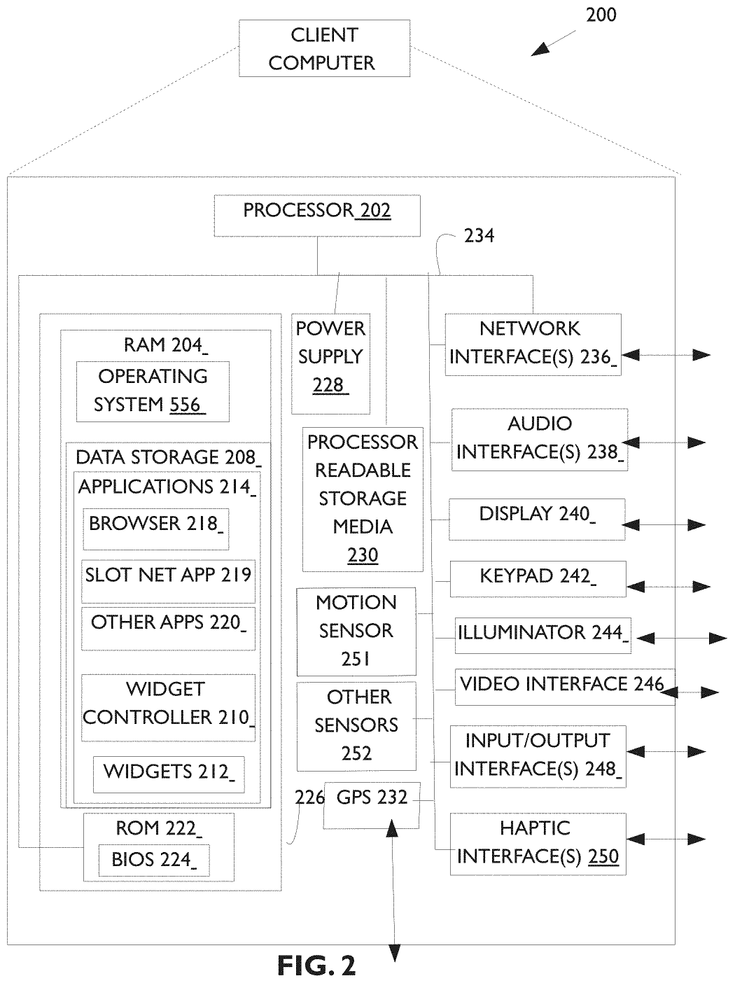

At least one embodiment of client computers 102-105 is described in more detail below in conjunction with FIG. 2. In one embodiment, at least some of client computers 102-105 can operate over a wired and/or wireless network, such as networks 110 and/or 108. Generally, client computers 102-105 can include virtually any computer capable of communicating over a network to send and receive information, perform various online activities, offline actions, or the like In one embodiment, one or more of client computers 102-105 can be configured to operate within a business or other entity to perform a variety of services for the business or other entity. For example, client computers 102-105 can be configured to operate as a web server, a production server, an inventory server, a host server, or the like. However, client computers 102-105 are not constrained to these services and can also be employed, for example, as an end-user computing node, in other embodiments. It should be recognized that more or less client computers can be included within a system such as described herein, and embodiments are therefore not constrained by the number or type of client computers employed.

Computers that can operate as client computer 102 can include computers that typically connect using a wired or wireless communications medium such as personal computers, multiprocessor systems, microprocessor-based or programmable electronic devices, network PCs, or the like. In some embodiments, client computers 102-105 can include virtually any portable personal computer capable of connecting to another computing device and receiving information such as, laptop computer 103, smart mobile telephone 104, and tablet computers 105, and the like. However, portable computers are not so limited and can also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client computers 102-105 typically range widely in terms of capabilities and features. Moreover, client computers 102-105 can access various computing applications, including a browser, or other web-based application.

A web-enabled client computer can include a browser application that is configured to receive and to send web pages, web-based messages, and the like. The browser application can be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client computer can employ the browser application to perform various activities over a network (online). However, another application can also be used to perform various online activities.

Client computers 102-105 can also include at least one other client application that is configured to receive and/or send content between another computer. The client application can include a capability to send and/or receive content, or the like. The client application can further provide information that identifies itself, including a type, capability, name, and the like. In one embodiment, client computers 102-105 can uniquely identify themselves through any of a variety of mechanisms, including an Internet Protocol (IP) address, a phone number, Mobile Identification Number (MIN), an electronic serial number (ESN), or other device identifier. Such information can be provided in a network packet, or the like, sent between other client computers, Slot Machine Network Server Computer 112, Network Server Computer 114, or other computers.

Client computers 102-105 can further be configured to include a client application that enables an end-user to log into an end-user account that can be managed by another computer, such as Slot Machine Network Server Computer 112, Network Server Computer 114, or the like. Such end-user account, in one non-limiting example, can be configured to enable the end-user to manage one or more online activities, including in one non-limiting example, search activities, social networking activities, browse various websites, communicate with other users, or the like. However, participation in such online activities can also be performed without logging into the end-user account. In at least one of the various embodiments, a client application includes a SMNT Application as described herein.

Wireless network 108 is configured to couple client computers 103-105 and its components with network 110. Wireless network 108 can include any of a variety of wireless sub-networks that can further overlay stand-alone ad-hoc networks, and the like, to provide an infrastructure-oriented connection for client computers 103-105. Such sub-networks can include mesh networks, Wireless LAN (WLAN) networks, cellular networks, and the like. In one embodiment, the system can include more than one wireless network.

Wireless network 108 can further include an autonomous system of terminals, gateways, routers, and the like connected by wireless radio links, and the like. These connectors can be configured to move freely and randomly and organize themselves arbitrarily, such that the topology of wireless network 108 can change rapidly.

Wireless network 108 can further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks can enable wide area coverage for mobile devices, such as client computers 103-105 with various degrees of mobility. In one non-limiting example, wireless network 108 can enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 can include virtually any wireless communication mechanism by which information can travel between client computers 103-105 and another computer, network, and the like.

Network 110 is configured to couple network computers with other computers and/or computing devices, including, Slot Machine Network Server Computer 112, Network Server Computer 114, client computer 102, and client computers 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks can utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links can further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 can be configured to transport information of an Internet Protocol (IP). In essence, network 110 includes any communication method by which information can travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

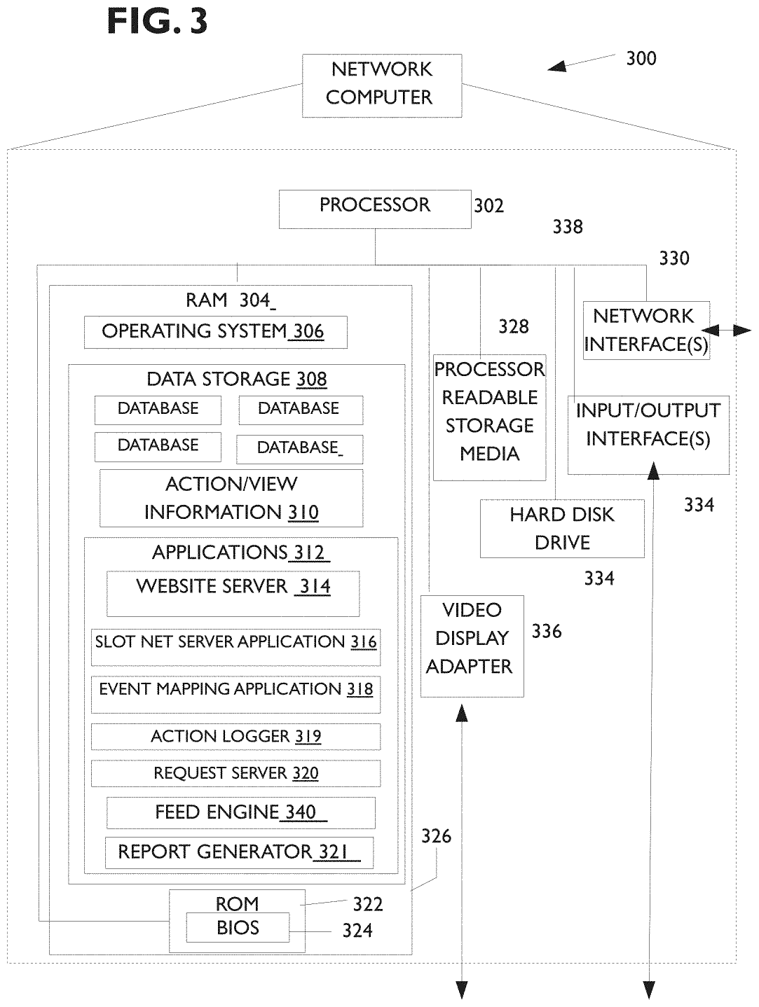

One embodiment of Slot Machine Network Server Computer 112 is described in more detail below in conjunction with FIG. 3. Briefly, however, Slot Machine Network Server Computer 112 includes virtually any network computer capable of providing the interfaces, tracking, databases and social networking capabilities as described herein. Computers that can be arranged to operate as Slot Machine Network Server Computer 112 include various network computers, including, but not limited to personal computers, desktop computers, multiprocessor systems, microprocessor-based or programmable consumer electronics, network PCs, server computers, network appliances, and the like.

Although FIG. 1 illustrates Slot Machine Network Server Computer 112 as a single computer, the embodiments are not so limited. For example, one or more functions of the Slot Machine Network Server Computer 112 can be distributed across one or more distinct network computers. Moreover, Slot Machine Network Server Computer 112 is not limited to a particular configuration. Thus, in one embodiment, Slot Machine Network Server Computer 112 can include a plurality of network computers. In another embodiment, Slot Machine Network Server Computer 112 can include a plurality of network computers that operate using a master/slave approach, where one of the plurality of network computers of Slot Machine Network Server Computer 112 is operative to manage and/or otherwise coordinate operations of the other network computers. In other embodiments, the Slot Machine Network Server Computer 112 can operate as a plurality of network computers arranged in a cluster architecture, a peer-to-peer architecture, and/or a cloud architecture. Thus, embodiments are not to be construed as being limited to a single environment, and other configurations, and architectures are also envisaged. In some embodiments, the Slot Machine Network Server Computer 112 may be enabled to deliver content, respond to user interactions with content, track user interaction with content, and update widget and widgets controllers, or the like.

### Illustrative Client Computer

FIG. 2 shows one embodiment of Client Computer 200 that can be included in a system implementing embodiments. Client Computer 200 can include many more or less components than those shown in FIG. 2. However, the components shown are sufficient to disclose an illustrative embodiment. Client Computer 200 can represent, for example, one embodiment of at least one of Client Computers 102-105 of FIG. 1.

As shown in the figure, Client Computer 200 includes a processor 202 in communication with a mass memory 226 via a bus 234. In some embodiments, processor 202 can include one or more central processing units (CPU). Client Computer 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232, and movement sensor 251.

Power supply 228 provides power to Client Computer 200. A rechargeable or non-rechargeable battery can be used to provide power. The power can also be provided by an external power source, such as an alternating current (AC) adapter or a powered docking cradle that supplements and/or recharges a battery.

Client Computer 200 can optionally communicate with a base station (not shown), or directly with another computer. Network interface 236 includes circuitry for coupling Client Computer 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 can be coupled to a speaker and microphone (not shown) to enable telecommunication with others and/or generate an audio acknowledgement for some action.

Display 240 can be a liquid crystal display (LCD), gas plasma, light emitting diode (LED), organic LED, or any other type of display used with a computer. Display 240 can also include a touch sensitive screen arranged to receive input from an object such as a stylus or a digit from a human hand.

Keypad 242 can comprise any input device arranged to receive input from a user. For example, keypad 242 can include a push button numeric dial, or a keyboard. Keypad 242 can also include command buttons that are associated with selecting and sending images.

Illuminator 244 can provide a status indication and/or provide light. Illuminator 244 can remain active for specific periods of time or in response to events. For example, when illuminator 244 is active, it can backlight the buttons on keypad 242 and stay on while the Client Computer is powered. Also, illuminator 244 can backlight these buttons in various patterns when particular actions are performed, such as dialing another client computer. Illuminator 244 can also cause light sources positioned within a transparent or translucent case of the client computer to illuminate in response to actions.

Video interface 246 is arranged to capture video images, such as a still photo, a video segment, an infrared video, or the like. For example, video interface 246 can be coupled to a digital video camera, a web-camera, or the like. Video interface 246 can comprise a lens, an image sensor, and other electronics. Image sensors can include a complementary metal-oxide-semiconductor (CMOS) integrated circuit, charge-coupled device (CCD), or any other integrated circuit for sensing light.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client computer. For example, the haptic interface 250 can be employed to vibrate client computer 200 in a particular way when another user of a computing computer is calling. In some embodiments, haptic interface 250 can be optional.

Motion sensor 251 is configured to detect and measure how a device is oriented in space and how the device accelerates when moved. Motion Sensor 251 components are arranged to provide for a wide range of motion detection, from rotation, bumps, gestures, shakes, and directional movements. Motion Sensor components can include an accelerometer, a gyroscope, a geomagnetic field sensor, vibration sensor, or other sensors 252.

Other sensors 252 can be arranged to detect and measure device environment or provide device sensing capabilities, for example, a light sensor, a temperature sensor, a capacitive touch sensor, and so on.

Client computer 200 can also include GPS transceiver 232 to determine the physical coordinates of client computer 200 on the surface of the Earth. GPS transceiver 232, in some embodiments, can be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 232 can determine a physical location within millimeters for client computer 200; and in other cases, the determined physical location can be less precise, such as within a meter or significantly greater distances. In one embodiment, however, client computer 200 can through other components, provide other information that can be employed to determine a physical location of the computer, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client computer 200. The mass memory also stores an operating system 206 for controlling the operation of client computer 200. It will be appreciated that this component can include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system can include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 can also be employed to store information that describes various capabilities of client computer 200. The information can then be provided to another computer based on any of a variety of events, including being sent as part of a header during a communication, sent upon request, or the like. Data storage 208 can also be employed to store social networking information including address books, buddy lists, aliases, user profile information, or the like. Further, data storage 208 can also store message, web page content, or any of a variety of user generated content. At least a portion of the information can also be stored on another component of client computer 200, including, but not limited to processor readable storage media 230, a disk drive or other computer readable storage devices (not shown) within client computer 200.

Processor readable storage media 230 can include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computer. Processor readable storage media 230 can also be referred to herein as computer readable storage media and/or computer readable storage device.

Applications 214 can include computer executable instructions which, when executed by client computer 200, transmit, receive, and/or otherwise process network data. Network data can include, but is not limited to, messages (e.g. SMS, Multimedia Message Service (MMS), instant message (IM), email, and/or other messages), audio, video, and enable telecommunication with another user of another client computer. Applications 214 can include, for example, browser 218, and other applications 220. Other applications 220 can include, but are not limited to, calendars, search programs, email clients, IM applications, SMS applications, voice over Internet Protocol (VOIP) applications, contact managers, task managers, transcoders, database programs, word processing programs, security applications (including biometric security such as fingerprint or face ID), timers, spreadsheet programs, games, and so forth.

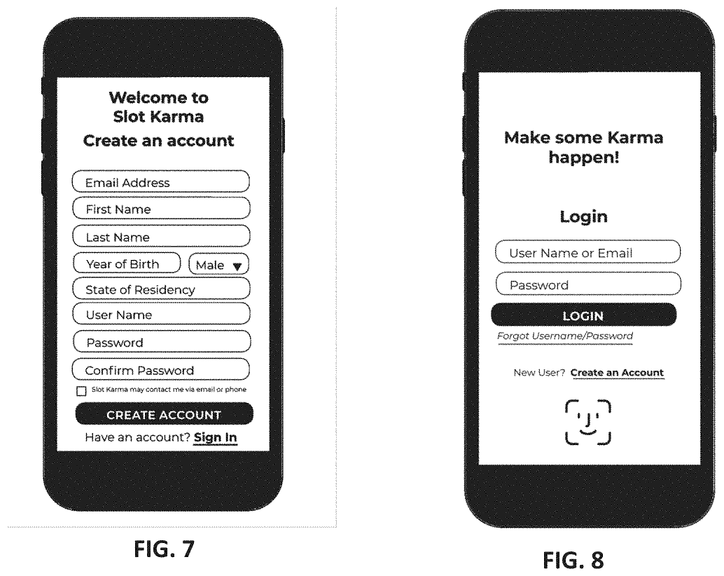

In an embodiment, applications 214 include a SMNT application 219. The SMNT application 219 is configured with interfaces and interface objects as described with respect to FIGS. 7-19. The SMNT application 219 is configured to interface with the client device 200 video interface 246 and motion sensor. The SMNT application 219 is further configured to include or interface with a timer to track the amount of time users are playing a slot machine. The SMNT application is configured interface with or include a search engine for searching databases as described herein.

Browser 218 can include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages can be employed. In one embodiment, browser 218 can enable a user of client computer 200 to communicate with another network computer, such as such as Slot Machine Network Server Computer 112 and/or Network Server Computer 114 of FIG. 1.

Applications 214 can also include Widget Controller 210 and one or more Widgets 212. Widgets 212 can be collections of content provided to the client computer by Slot Machine Network Server Computer 112. Widget Controller 210 can be a program that can be provided to the client computer by Slot Machine Network Server Computer 112. Widget Controller 210 and Widgets 212 can run as native client computer applications or they can run in Browser 218 as web browser based applications. Also, Widget Controller 210 and Widgets 212 can be arranged to run as native applications or web browser applications, or combination thereof.

### Illustrative Network Computer

FIG. 3 shows one embodiment of a network computer 300. Network computer 300 can include many more or less components than those shown. The components shown, however, are sufficient to disclose an illustrative embodiment. Network computer 300 can be configured to operate as a server, client, peer, a host, or any other computer. Network computer 300 can represent, for example Slot Machine Network Server Computer 112 of FIG. 1, and/or other Network Computers 114.

Network computer 300 includes processor 302, processor readable storage media 328, network interface unit 330, an input/output interface 332, hard disk drive 334, video display adapter 336, and memory 326, all in communication with each other via bus 338. In some embodiments, processor 302 can include one or more central processing units.

As illustrated in FIG. 3, network computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network computer 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network computer 300. Any general-purpose operating system can be employed. Basic input/output system (BIOS) 324 is also provided for controlling the low-level operation of network computer 300.

Although illustrated separately, memory 326 can include processor readable storage media 328. Processor readable storage media 328 can be referred to and/or include computer readable media, computer readable storage media, and/or processor readable storage device. Processor readable storage media 328 can include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 326 further includes one or more data storage 308, which can be utilized by network computer 300 to store, among other things, applications 314 and/or other data such as content 310. For example, data storage 308 can also be employed to store information that describes various capabilities of network computer 300. The information can then be provided to another computer based on any of a variety of events, including being sent as part of a header during a communication, sent upon request, or the like. Data storage 308 can also be employed to store messages, web page content, or the like. At least a portion of the information can also be stored on another component of network computer 300, including, but not limited to processor readable storage media 328, hard disk drive 334, or other computer readable storage medias (not shown) within client computer 300.

Data storage 308 can include a database, text, spreadsheet, folder, file, or the like, that can be configured to maintain and store user account identifiers, user profiles, email addresses, IM addresses, and/or other network addresses; or the like.

In at least one of the various embodiments, Data storage 308 can include action/view information 310, which can contain information determined from one or more events for one or more users. Action/View Information 310 can include historical information for a user activity as well as comparison information based on some user activity that can be associated with the system.

In at least one of the various embodiments, Data storage 308 can further include a slot machine database 360, a user profile database 342, a connections database 344. In the slot machine database 360, slot machine profiles can be arranged by casino. In an embodiment, the system can also include a casino database 343 comprising casino profiles and slot machine information as described herein.

Data storage 308 can further include program code, data, algorithms, and the like, for use by a processor, such as processor 302 to execute and perform actions. In one embodiment, at least some of data store 308 might also be stored on another component of network computer 300, including, but not limited to processor-readable storage media 328, hard disk drive 334, or the like.

Applications 312 can include computer executable instructions, which can be loaded into mass memory and run on operating system 306. Examples of application programs can include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, payment applications, and so forth. Applications 312 can also include website server 314, SMNT Application Server 316, Privacy Server 362, Event Mapping Application 318, Action Logger 319, Request Server 320, and/or Feed Engine 340.

Website server 314 can represents any of a variety of information and services that are configured to provide content, including messages, over a network to another computer. Thus, website server 314 can include, for example, a web server, a File Transfer Protocol (FTP) server, a database server, a content server, or the like. Website server 314 can provide the content including messages over the network using any of a variety of formats including, but not limited to WAP, HDML, WML, SGML, HTML, XML, Compact HTML (cHTML), Extensible HTML (xHTML), or the like.

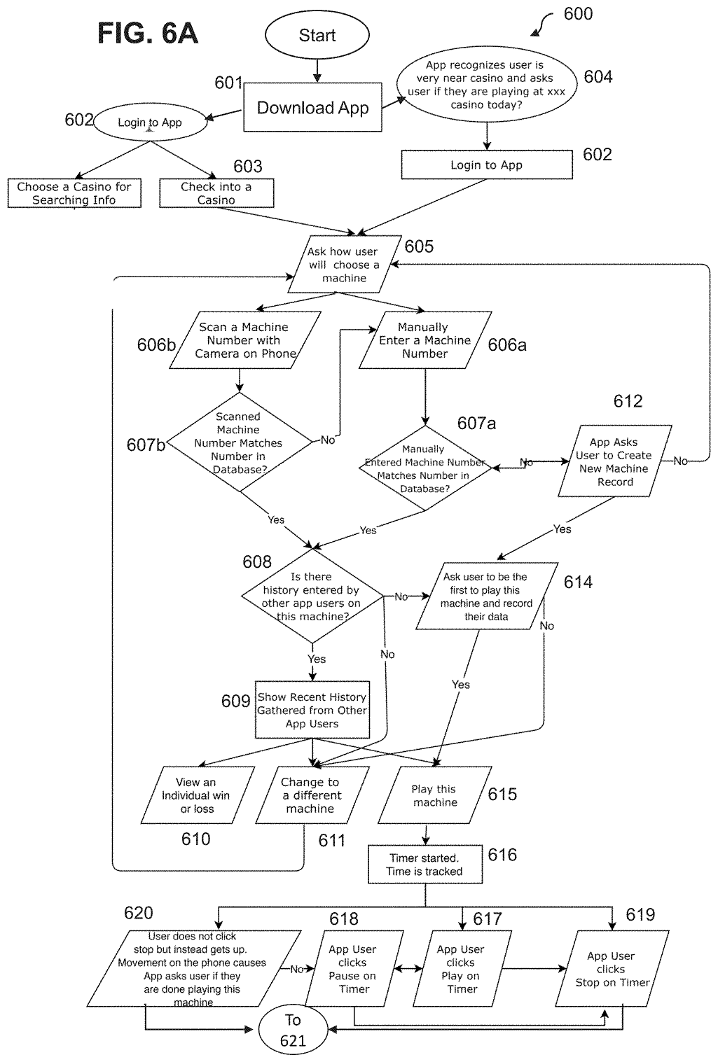

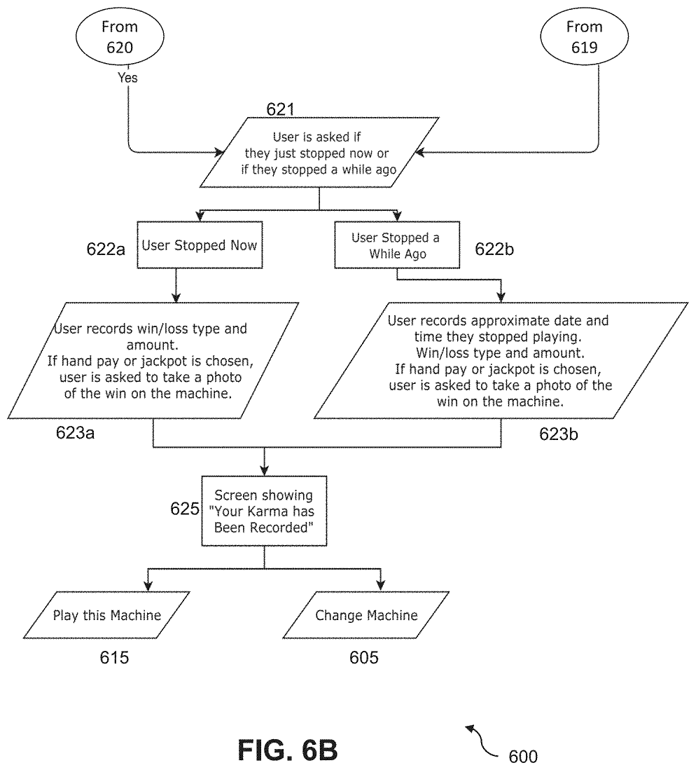

Applications 312 can be configured to provide webpage and application tool interfaces that can be hosted on Slot Machine Network Server Computer 112, or the like. Applications 312 can employ processes, or parts of processes, similar to those described in conjunction with the use cases of FIGS. 6A-19, to perform at least some of its actions.

SMNT Application Network Application Server 316 can be configured to provide page and application tool and search interfaces that can be hosted on Slot Machine Network Server Computer 112 and served to Slot Machine Network Applications 219 on client devices, or the like. Applications 312 can employ processes, or parts of processes, similar to those described in conjunction with the process flow and use cases of FIGS. 6A-19, to perform at least some of its actions.

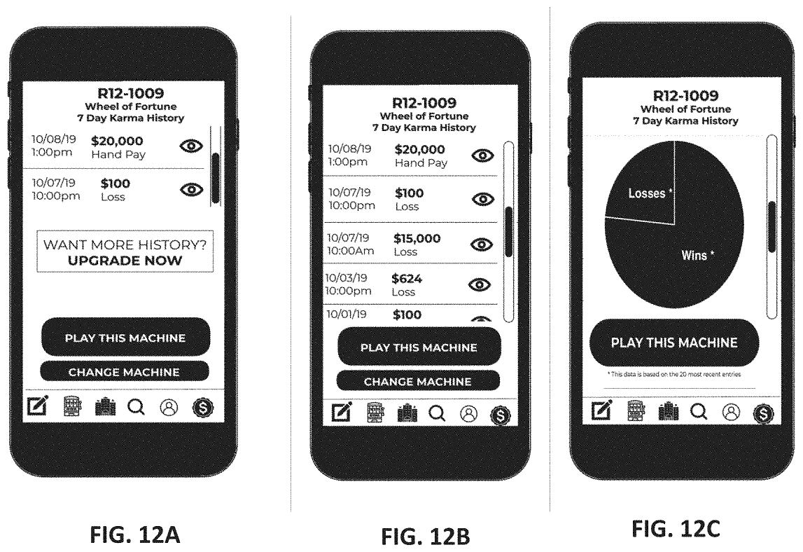

Feed Engine 320 can be arranged and configured to provide a feed to users. In at least one of the various embodiments, Feed Engine 320 can be operative on Slot Machine Network Server Computer 112. In any event, Feed Engine 320 can employ processes, or parts of processes, similar to those described in conjunction with FIGS. 12A-12B, 17B and 18A-18B to perform at least some of its actions.

Report Generator 321 can be arranged and configured to determine and/or generate reports based on the slot machine and payout tracking. In at least one of the various embodiments, Report Generator 321 can be operative on Slot Machine Network Server Computer 112 of FIG. 1. In any event, Report Generator 321 can employ processes, or parts of processes, similar to those described in conjunction with FIGS. 6A-19, to perform at least some of its actions.

### Illustrative Logical System Architecture

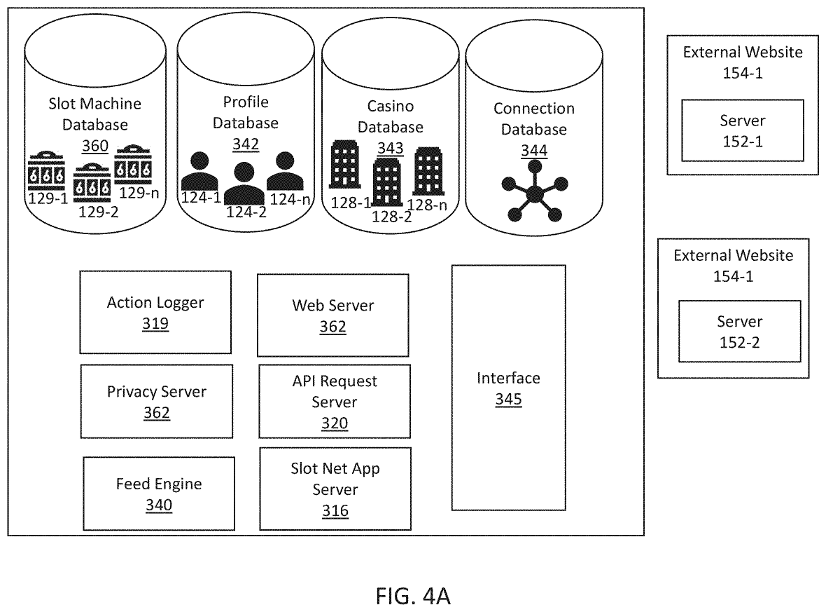

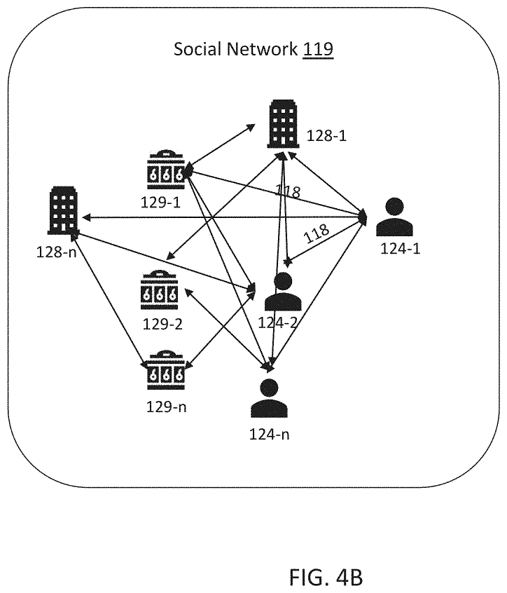

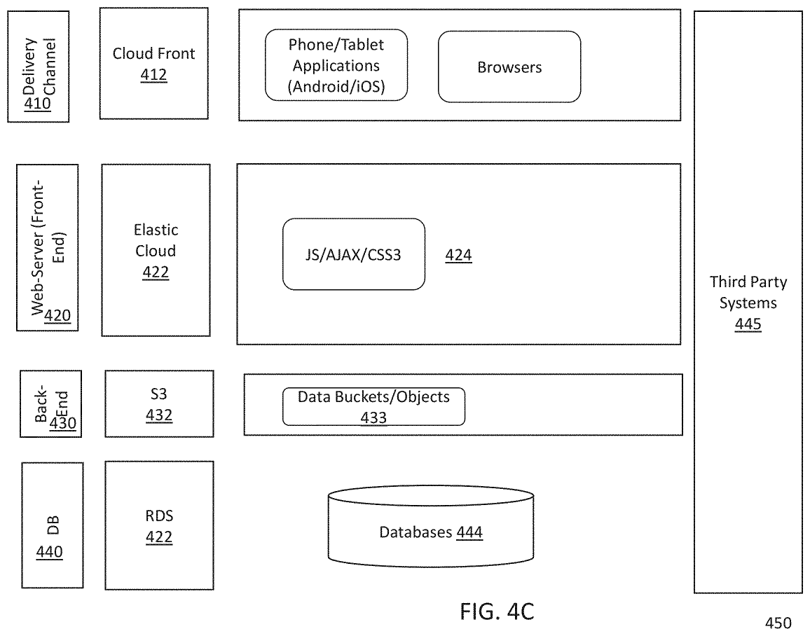

FIGS. 4A-4C illustrate block diagrams of a logical architecture 400 for a Slot Machine Network Server 112 in accordance with at least one of the various embodiments. As used herein, the term “website” means any system providing content and is not limited to those systems supporting content provided via the Internet or the http protocol. In general functions described herein as being performed on the server side may also be performed on the client side as appropriate.

The Slot Machine Network Server Computer 112 has a web server 314, an action logger 319, an application programming interface (API) request server 320, an action log 338, a feed engine and generator 316, a user profile database 342, a connection database 344, and a page/app interface 345, a slot machine database 360, and a casino database 343. The Slot Machine Network Server Computer 112 is configured to host databases and generate web and application interfaces as described with respect to FIGS. 6A-19. The Slot Machine Network Server Computer 112 may include more or less features, or may include modifications of the features described herein. Conventional features, such as firewalls, load balancers, application servers, fail over servers, site management tools, as well as additional conventional known features are not shown to allow a clearer illustration of the novel features of the system.

The Slot Machine Network Server Computer 112 allows a user to create a user profile 128. The Slot Machine Network Server Computer also stores information regarding the connections 118 associated with the user profile 124.

The Slot Machine Network Server Computer 112 includes slot machine profiles 129-n. The Slot Machine Network Server Computer 112 allows a user to create a slot machine profile 129 as described herein. Each slot machine profile 129-1 can include, record, and be searched by a machine identification number, a casino, a location, and slot machine events, for example payout event information (e.g. win, loss, amount, payout type, payout history), name, as well as other information about the machine. In embodiments, the slot machine profile 219-n can include information linked to users and user profiles, such as photos, videos, and player history information.

The Slot Machine Network Server Computer 112 can comprise casino profiles 128-n. Each casino machine profile 128 can include or be linked to slot machine profile 129-n and user profile information 124-n.

The Slot Machine Network Server Computer also stores information regarding the connections 118 associated with user profiles 124, slot machine profiles 129, and casino profiles 128.

Slot Machine Database 360, Profile Database 344, Casino Database 343, and Connection Database 344 can be configured to be cross-referenced and searchable across the databases. In an embodiment, data can be organized by: machine, casino, and user. Data can be searchable across any casino in the database and for any slot machine in the database. Exemplary databases can be arranged to track and search, inter alia:

Casino+User: users 124-n that play at a casinos;

User+Casino all casinos a user 124-1 plays at;

Machine+User: all users 124-n that play a particular machine 129-1

User+Machine: all machines 129-n that a user 124-1 plays)

Casino+Machine (able to track all machines 129-n at a particular casino.

As will be appreciated, in various embodiments one or more of Slot Machine Database 360, Profile Database 344, Casino Database 343, and Connection Database 344 can be included in the same database or in separate databases.

In addition to serving webpages and application interfaces to the users via the Slot Machine Network Server Computer 112, the Slot Machine Network Server 112 can serve other web related content, such as Flash, Java, XML and similar content. The web server 332 is provided with a message server 350 to allow messages to be transmitted between the profiles 124, 126, 128 and 148 associated with the slot machine network 112. The messages may be in the form of email, chat, text, SMS, or any desired messaging format known in the art.

In an exemplary embodiment, an API request server 320 can correspond to one or more dynamic link libraries DLL or other libraries that comprise standardized functions for communicating with a web server 362. The API request server 320 allows servers 152-1, 152-2 associated with external websites 154-1, 154-2 to access information associated with the Slot Machine Network Server Computer by calling APIs 320 and to execute operations on the Slot Machine Network Server Computer, such as sending messages to other user profiles, by calling other APIs. The external websites 154-1, 154-2 can be any websites operating from a server 114 other than the server operating the Slot Machine Network Server 112, for example, social networks, media hosting services or other external websites 154-1, 154-2.

In an embodiment, an action logger 319 can monitor actions of users and between users, whether such actions take place on their respective profiles 124 and 148, elsewhere on the Slot Machine Network Server Computer 112 or, if authorized, other places outside of the Slot Machine Network Server Computer 112. All actions of the users are monitored by the action logger 334 are recorded and stored in the action log 338 or other database. Types of actions that may be recorded and stored include, but are not limited to, requesting connections between members, authorizing connections between members, posting slot machine events, sending messages between members, opening messages between members, suggesting connections, viewing content on other member's profiles, requesting, announcing or RSVPing to events.

The feed generator 340 displays published objects in reverse chronological order on each user profile's interface feed as described herein with respect to, inter alia, slot machine event information. The Slot Machine Network Server Computer 112 can also be provided with a privacy server 362 that can restrict access to information stored on the Slot Machine Network Server 112. In an embodiment, the user may be allowed to modify settings associated with the privacy server 362 via the user profile 124 to determine how information related to the user 102 is stored and shared on the Slot Machine Network Server Computer 112. For example, the privacy server can be configured to allow users to see only their own profile data and slot machine data, but not others' data or only data made accessible via a social network 118 connection.

As shown in FIG. 4B, in an embodiment, the architecture can be configured as a social network 119. A user can be a member of a social network 119. Generally, the social network 119 provides its members with a platform to interact with other members of the social network 119. The members may link to one another, or otherwise make internal connections 118, by authorizing other members to access information associated with their user profiles 124 as described herein. Members may add connections 118 to other members individually, or may add teams of members associated with a particular organization, hobby or group as allowed by the social network 119. Alternatively, the social network 119 may automatically add connections 118 between members given various members' similar interests in various activities or past connections, such as work history or prior matriculation. In at least one of the various embodiments, the social network can create connections between user profiles 124 and slot machine profiles 129. The social network 119 can be configured to add connections 118 between members based on slot machine event information or casino information.

Connections 118 can be “two-way” connections 120, where both parties are allowed to directly communicate with one another or “one-way” 118 connections where a user profile 124-1 authorized to communicate directly with another user's profile 124-2, but the other user's profile 124-2 is not authorized to communicate directly with the user profile 124-1. The other user's profile 124-2 may still have access to other information associated with the user profile 124-1, for example via a following feed, but may be restricted from adding text, video or pictures to the user profile 124-1 or from sending non- public communication to the user profile 124-1 within the social network 119. The social network 119 may also allow expanded rings of communication, whereby even if one user profile 124-1 is not directly authorized to communicate with another user profile 124-n, if the user profile 124-1 is authorized to connect to other user profiles 124n which are authorized to directly communicate with the user profile 124-1, the user profile 124-n is thereby authorized, through this string of authorizations, to communicate directly with the user profile 124. In an embodiment, slot machine profiles 129 and casino profiles 128 can similarly communicate via profile connections as described above.

In an embodiment, the user may authorize the Slot Machine Network Server Computer 112 to share information about the user only with specifically authorized members associated with Slot Machine Network Server Computer with various software applications, external systems or any system seeking access to the information. The information stored by the user on the Slot Machine Network Server Computer may include text, photographs, audio recordings, video, including contact lists and connections formed by the user through the Slot Machine Network Server Computer.

FIG. 4C shows a logical architecture 450 for an embodiment. The system can be built on an exemplary platform, for example Amazon Web Service platform, although other platforms for supporting application content delivery, social networking and network infrastructure can be employed. As shown in FIG. 4C, a Delivery Channel tier 410 can be provided via a cloud front 412 to client computers as described herein. A front-end web server tier 420 can be built on an elastic cloud (EC2) architecture 422 can provide front end interfaces, for example such as interfaces built on Angular JS 424 or other JS modules. The back-end tier 430 can be operatively connected to front end architecture tier 420 by web sockets 402, and can be built on an S3 architecture 432 and include data buckets and objects 433 for web-scale data storage and retrieval, and the databases layer 440 can include, for example, a databases 444 on an Relational Database Structure (422) tier 442 architecture. One or more third party systems 445 can be integrated or operatively connected to the architecture 450. As will be appreciated, provision of tiers and builds are exemplary, other platforms for supporting social networking and network infrastructure can be employed.

One of ordinary skill in the art will appreciate that the architecture of system is a non-limiting example that is illustrative of at least a portion of at least one of the various embodiments. As such, more or less components can be employed and/or arranged differently without departing from the scope of the innovations described herein. However, system is sufficient for disclosing at least the innovations claimed herein.

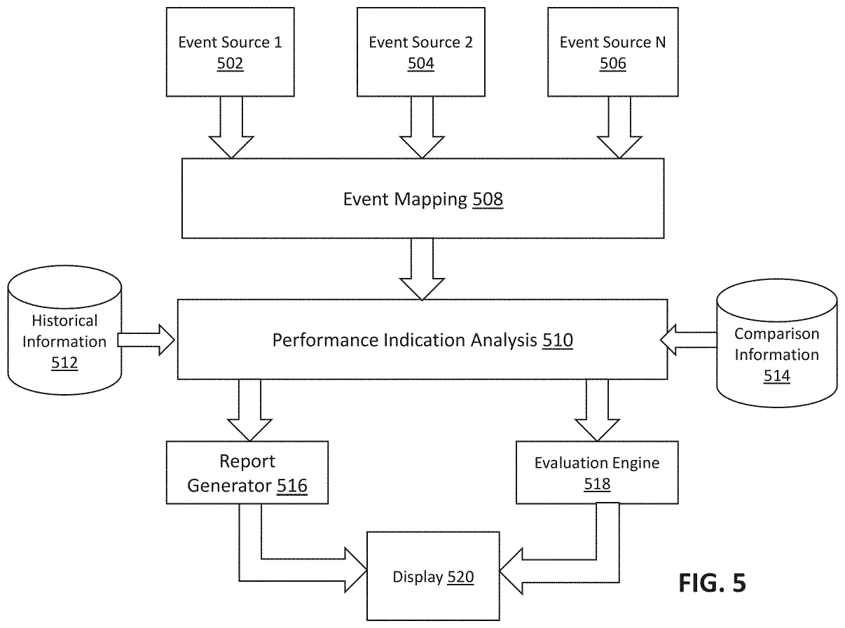

In an embodiment, the system can be configured for slot machine, user, and casino analytics. FIG. 5 represents a logical architecture for system 500 for multi-source performance and exposure for analytics in accordance with at least one of the various embodiments. In at least one of the various embodiments, events from one or more event sources, such as, event source 502, event source 504, or event source 506 can be determined. In at least one of the various embodiments, event sources can include client computers providing, inter alia, slot machine information including payout event information as described herein. In at least one of the various embodiments, the determined events can correspond to various user interactions, display operations, impressions, or the like, related to content that can be managed by a content management server, such as Slot Machine Network Server Computer 112, Network Computer 114, or the like. In at least one of the various embodiments, system 500 can include more or fewer event sources than shown in FIG. 5.

In at least one of the various embodiments, events that can be received and/or determined from one or more event sources can be process in event mapping component 508. In at least one of the various embodiments, given the disparate sources of the determined events they can be defined using dissimilar criteria and/or definitions. Further, in at least one of the various embodiments, the various event sources can provide event information using a variety of data formats and/or communication protocols. Thus, event mapping component 508 can be arranged to map to determined events into one or more actions and/or views. In at least one of the various embodiments, this mapping can normalize events that can be received from disparate event sources.

In at least one of the various embodiments, event mapping component 508 can be arranged to use one or more filters, tests, rules, regular expressions, pattern matches, lookup tables, heuristics, or the like, for mapping the determined events to actions and/or views. In some embodiments, event mapping component 508 can be arranged to determine the particular, filters, tests, rules, regular expressions, pattern matches, lookup tables, heuristics, or the like, for mapping events based on the event source. For example, a Slot Machine Network Server Computer 112 can be configured to employ a particular set of filters and rules for mapping events from a particular source.

In at least one of the various embodiments, event mapping component 508 can generate one or more actions and/or views based on the determined events. In at least one of the various embodiments, information corresponding to each action and/or view can be stored using well-known data structures such as objects, hashes, arrays, linked lists, or the like. In at least one of the various embodiments, the action information and/or the event information can be stored in a database and associated with at least a casino and a slot machine that corresponds to the content that is associated with the determined events.

In at least one of the various embodiments, analysis component 510 can be arranged to determine events based on the action information and/or view information associated with a client user and/or a slot machine. In at least one of the various embodiments, analysis can include analysis of wins and win values of slot machines reported by users on the slot machine network 112.

Also, in at least one of the various embodiments, performance information analysis can include determining historical information from a record store, such as, historical information database 512. In at least one of the various embodiments, historical information database 512 can include slot machine information, casino information, win information, and user information, or the like.

In at least one of the various embodiments, performance analysis can include determining comparison information from a record store, such as, comparison information database 514. In at least one of the various embodiments, comparison information database 514 can include slot machine information, casino information, win information, and user information, or the like, or the like. Thus, in at least one of the various embodiments, comparison information database 514 can be a storehouse of slot machine performance information.

In at least one of the various embodiments, information from information analysis component 510 can flow to report generator 516 and/or evaluation engine 518. In at least one of the various embodiments, report generator 516 can be arranged to generate one or more reports based on the analysis information. In at least one of the various embodiments, reports can include historical information or comparison information. In at least one of the various embodiments, reports can be determined and formatted based on one or more report templates.

In at least one of the various embodiments, dashboard display 520 can render a display of the information produced by the other components of the systems. In at least one of the various embodiments, dashboard display 520 can be presented on a client computer accessed over network, such as client computers.

In at least one of the various embodiments, event information can be stored in one or more data stores, for later processing and/or analysis. Likewise, in at least one of the various embodiments, event information can be processed as it is determined or received. Also, event information can be stored in data stores, such as databases, for use as historical information and/or comparison information.

### Generalized Operation

The operation of certain embodiments will now be described with respect to FIGS. 6A-6B and FIGS. 7-19. In at least one of various embodiments, process 600 as described in conjunction with FIGS. 6A-6B and graphical user interfaces FIGS. 7-19 can be implemented by and/or executed from a single network computer, such as network computer 300 of FIG. 3. In other embodiments, these processes or portions of these processes can be implemented by and/or executed on a plurality of network computers, for example in a cloud architecture as shown in FIG. 4C. Likewise, in at least one of the various embodiments, processes 600, or portions thereof, can be operative on one or more client computers, such as client computer 200. However, embodiments are not so limited, and various combinations of network computers, client computers, virtual machines, or the like can be utilized. Further, in at least one of the various embodiments, the processes described in conjunction with FIGS. 6A-6B and 7-19 can be operative in system with logical architectures such as those described in conjunction with FIGS. 4A-4C and FIG. 5.

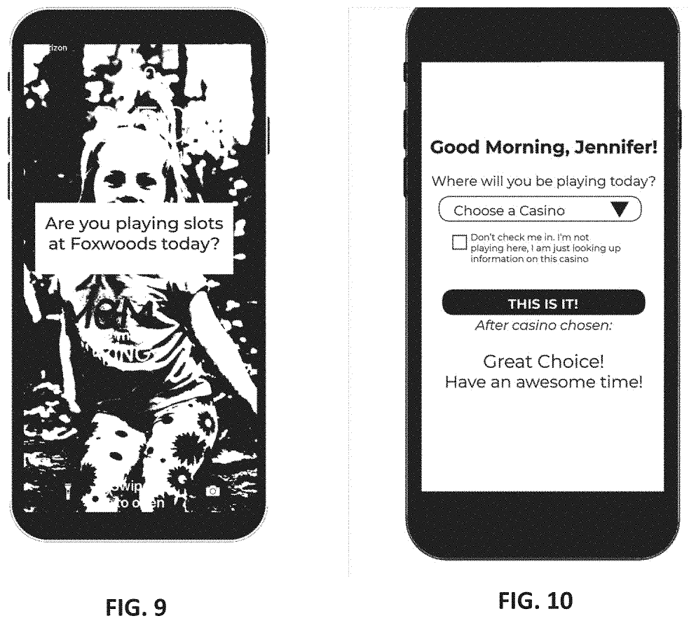

FIGS. 6A-6B illustrate an overview flowchart for process 600 for a SMNT Application in accordance with at least one of the various embodiments. After a start block, at block 601, in at least one of the various embodiments, a user downloads an SMNT application into a user device. If the use is a first time use, SMNT application is configured to allow user to create an account, for example using the account creation interface shown in FIG. 7. At block 602, the user logs in to an account. An exemplary interface for logging into an account is shown at FIG. 8. At block 603 the user checks into a casino. In an embodiment, at block 604, and as shown in the exemplary interface of FIG. 9, the application employs location tracking (e.g. via GPS), and is configured to recognize the user is located at a specific casino. The application can also be configured to allow the user to search for a casino. An exemplary interface for searching for a casino is shown at FIG. 10. In an embodiment, the system uses the casino choice to filter for slot machine profiles and records linked to that casino.

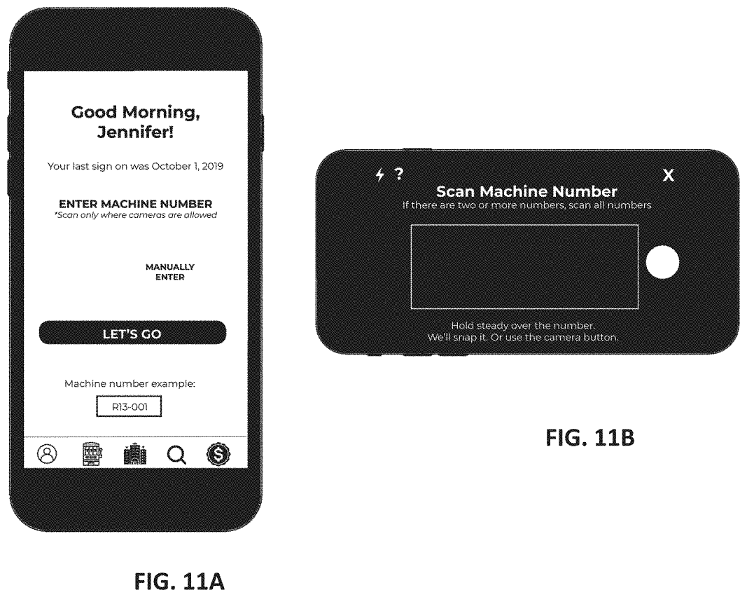

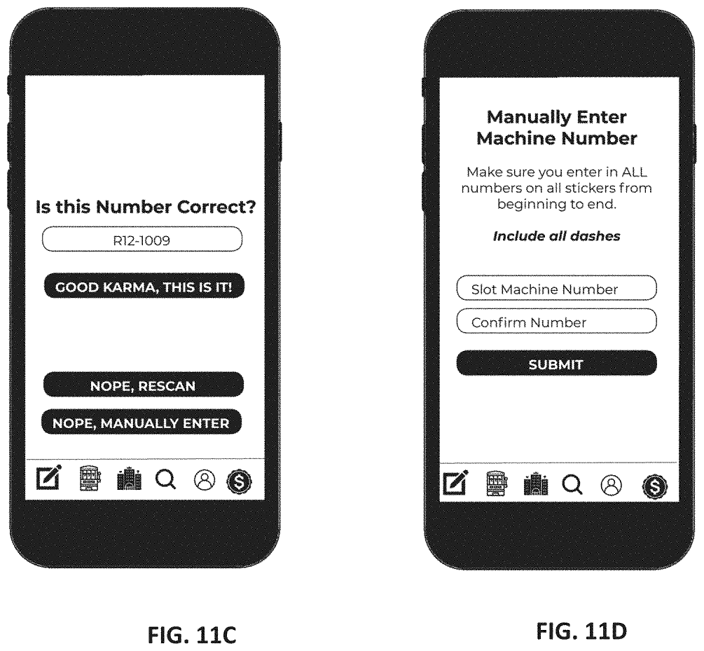

At block 605, the SMNT application can be configured to prompt a user to select a specific slot machine. The SMNT application can be configured to allow the user to select a machine in a number of ways. For example, at block 606a, the application can present an interface to allow a user to manually enter a slot machine identification number. Exemplary interfaces for allowing a user to manually enter a slot machine identification number are shown in FIG. 11A and FIGS. 11C-11D. For another example, at block 606b the application can be configured to allow the user to scan a slot machine identification number, for example using the user device's camera to scan a machine number and visually map the number or a barcode. In another embodiment, the application can be configured to interface with a voice-to-text module to allow the user to enter the number by voice. Exemplary interfaces for allowing a user to scan a slot machine identification number are shown in FIGS. 11A-11C.

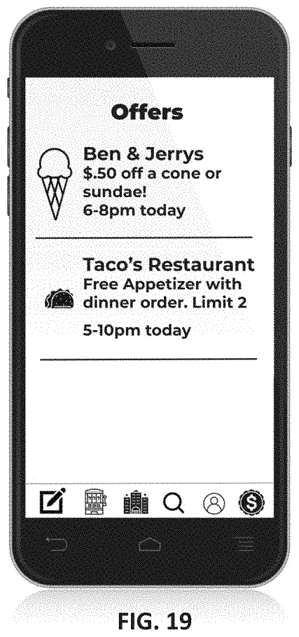

At block 607a/607b the system then searches the slot machine profile database 360 to determine if slot machine identification number has a profile and a history. At block 608, if the slot machine has a profile and history, at block 609 the system is configured to present the record to the user. An exemplary interface showing a slot machine win/loss history is shown in FIGS. 12A-12C. As shown in FIG. 12A, the system can be configured to show a limited history and give a user to unlock a longer history as shown in FIG. 12B (e.g. by upgrading or accepting special offers as shown in FIG. 19). In an embodiment, the wins and losses can be displayed as an interactive graphic, for example a pie chart as shown in FIG. 12C. For example, for a given slot machine, the system can be configured to take a number of the most recent entries (e.g. 10-50) and put the wins and losses into a pie chart to visually show how the machine has been performing. The interface can be configured to let the user click on the pie chart to see all of the entries for the chart with a summary at the top of the screen. As will be appreciated, the history can be configured to display wins and losses for up to any number of entries and/or selected time periods (e.g. n hours, n days, n weeks, n months, all times/entries) for the display.

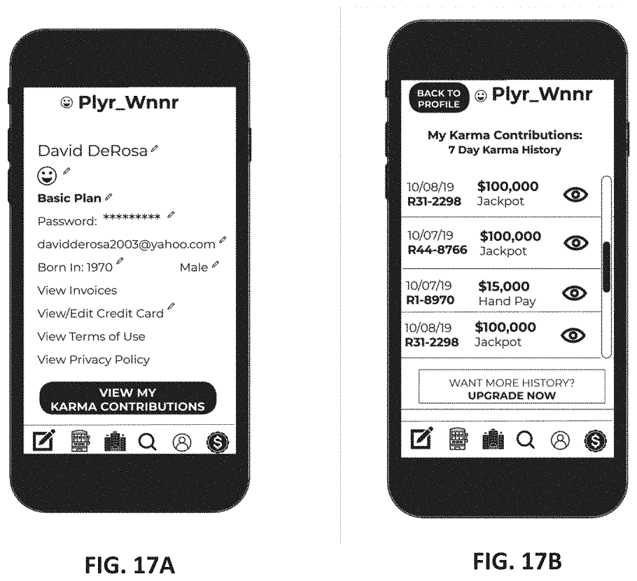

At block 610, the user can choose to view individual wins and losses as well, as shown in the exemplary interface of FIG. 17B. At block 615, the user chooses to play the machine. At block 611, if a user chooses not to play the machine, the SMNT application is configured to allow a user to change to a different machine. The SMNT application then returns to block 605, where the user chooses a different machine.

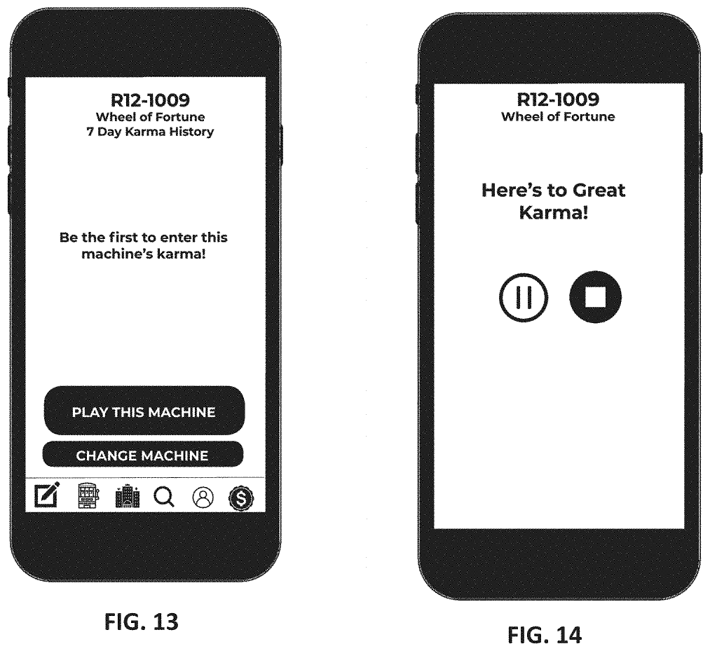

If at block 607 the system determines a slot machine does not have a profile and history, at block 612, the SMNT application is configured to allow the user to create a new slot machine profile. At block 613, if the user chooses not to create a new slot machine profile, the SMNT application then returns to block 605, where the user chooses a different machine. If the user chooses to create a new slot making profile, at block 614 the application is configured to prompt the user to be the first player to submit play data to the system. An exemplary interface for so prompting as user is shown in FIG. 13. If not, the system again returns to block 605. If the user chooses to submit a play record, at block 615 the user plays the machine.

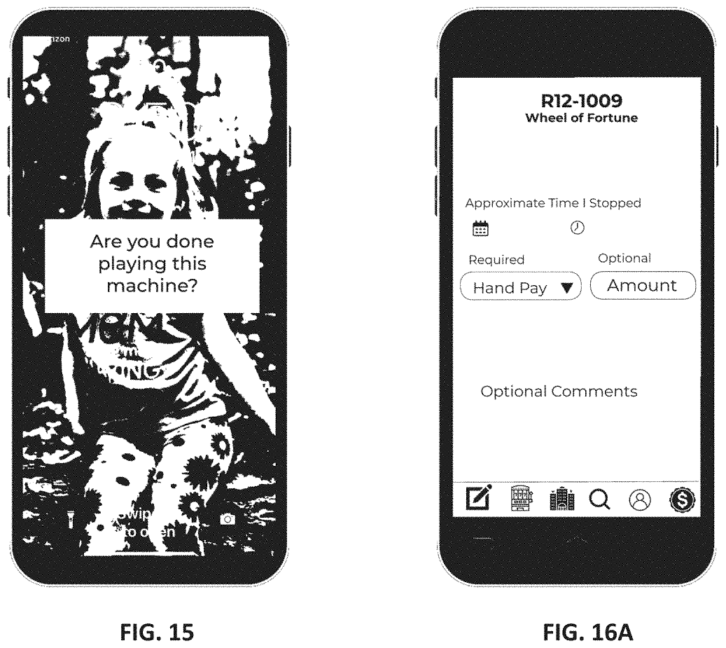

When a user chooses to play the slot machine at block 615, at block 616 the application starts a timer, and machine play time is tracked. At block 617, the user can choose to click on a timer interface object to start the timer, and at block 618 the user can choose to pause the timer, and at block 619, stop the timer. An exemplary interface for pausing or stopping machine play tracking is shown in FIG. 14. In an embodiment, at block 620, if the user device includes a motion sensor or accelerometer on the user device, the application can be configured to prompt the user if they are finished playing. If the user stops the timer at block 619 or responds yes to the prompt at block 620, at block 621 the application prompts the user to ask if they have just stopped or if they stopped some time ago. An exemplary interface for so prompting as user is shown in FIG. 15. In an embodiment, the system can be configured to make this determination on its own. For example, the system can be configured to track the time from when a user stopped the timer or moved, and if a predetermined time has passed (e.g. a threshold of anywhere from 60 minutes to 24 hours or other amount of time) to determine if the user has now or recently stopped playing the machine or not.

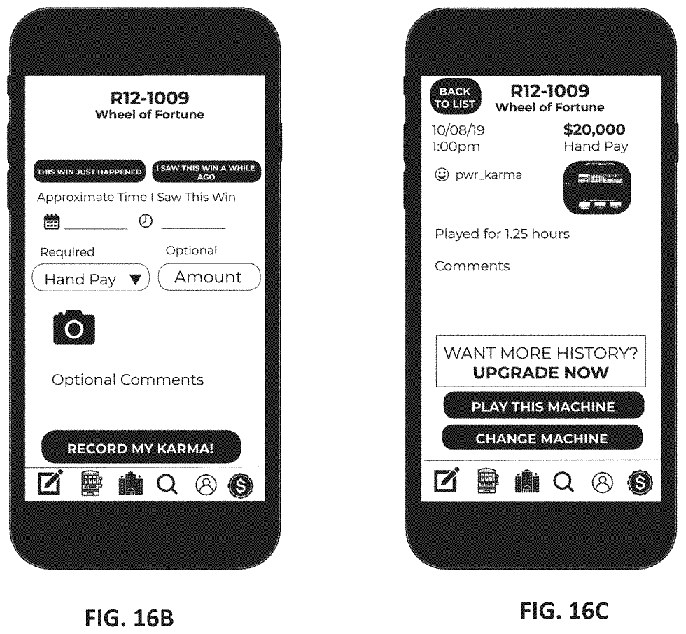

At block 622a, if the user replies or the system determines they have just stopped, at block 623a the system is configured to have the user record the payout amount with win or loss type and the amount. An exemplary interface for recording a win or loss and amount for the slot machine is shown in FIGS. 16-16B. At block 622b, if the user replies or the system determines they stopped some time ago, at block 623b the system is configured to have the user record with win or loss type and the amount as well as the approximate time and date they stopped playing. In an embodiment, at block 623a/623b the system can be configured to allow the user to take a photo of the machine and the win or loss, for example, a photo of a hand pay or a jackpot. At block 625, the system then confirms the record has been posted and linked to the slot machine profile history, for example with a confirmation screen, as shown in the exemplary interface of FIG. 16C. The user can then use the SMNT application to choose to play the same machine at block 615 or choose another machine at block 605.

As noted above, at block 610, the user can choose to view individual wins and losses as well, as shown in the exemplary interface of FIG. 17B. For example, the SMNT application is configured to present a profile page where a user can choose to display tracked wins and losses, as shown in FIGS. 17A-17B.

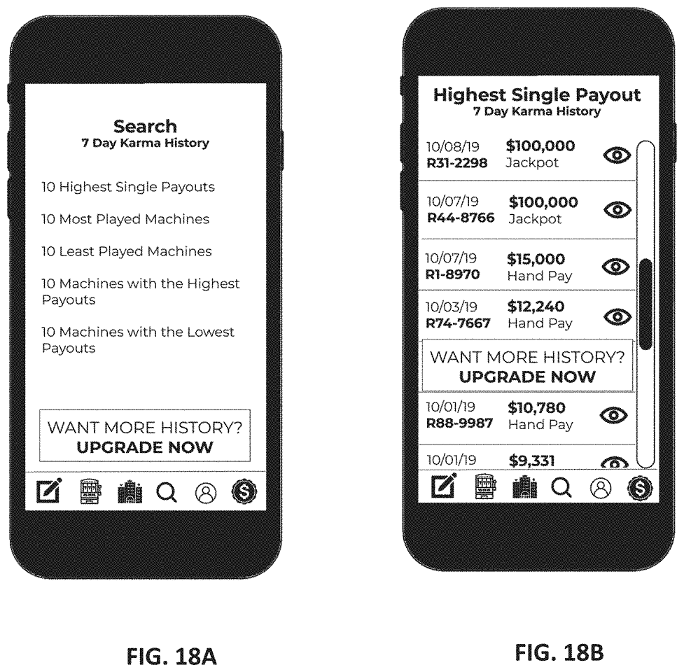

In an embodiment, the user can search the slot machine database 360 for slot machine information. For example, as shown in the exemplary interface of FIG. 18A, the system is configured provide slot machine histories for payouts (e.g. highest single payouts, most payouts, lowest payouts, highest losses, most losses, lowest losses), most or least played, hand pays, and so on.

In an embodiment, the system can be configured to allow a user to record wins and losses for machines the user sees, even if they themselves did not play. An exemplary interface is shown at FIG. 16B. As will be appreciated, the SMNT application is configured to allow the user to enter slot machine identification numbers, create slot machine profiles, and record wins and losses via the process 600 shown in FIGS. 6A-6B even if the user did not themselves play the machine.

In an embodiment, the system can be configured to include additional social network functionality, for example, friending, sharing, liking, etc. In an embodiment, the SMNT application can include a feed interface for feeds that include activity logs. In an embodiment, slot machine profiles can be followed and liked in the same manner as friends or connections, where the activity for that slot machine is presented in a user's feed.

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

### Illustrative User Interface Use Cases

FIGS. 7-19 represent graphical user interfaces for slot machine and casino tracking with at least one of the various embodiments. In at least one of the various embodiments, user interfaces other than user interfaces described herein can be employed without departing from the spirit and/or scope of the claimed subject matter. Such user interfaces can have more or fewer user interface elements which can be arranged in various ways. In some embodiments, user interfaces can be generated using web pages, mobile application the like. In at least one of the various embodiments, computers as described herein can include processes and/or APIs for generating user interfaces, such as the user interfaces as shown herein.

1. A system for tracking slot machines over a network, comprising:
a network computer, including:
a transceiver for communicating over the network;
a memory for storing at least instructions and a data store;
a processor device that is operative to execute instructions that enable actions, including:
serve an application configured to allow a user to create a slot machine profile and input and display slot machine event data on a user device;
store the slot machine profile in a slot machine database;
accept slot machine event data for the slot machine profile, the slot machine event data including payout event data from the application; and
map the slot machine event data to the slot machine profile.

2. The system of claim 1, wherein the system further comprises:
a user profile database comprising a plurality of user profiles;
a slot machine profile database comprising a plurality of slot machine profiles generated via a plurality of the applications; and
a casino database comprising casino profiles.

3. The system of claim 2, wherein the system further comprises:
a connection database comprising connections between the casino profiles, the user profiles, and the slot machine profiles.

4. The system of claim 3, wherein the casino database, and connection database are cross-referenced by casino profiles, user profiles, slot machine profiles, and the connections between the casino profiles, the user profiles, and the slot machine profiles.

5. The system of claim 4 wherein the cross-referenced databases are searchable across the databases.

6. The system of claim 4, wherein the system is configured to operate as a social network, and the system further comprises:
an action logger;
a privacy server; and
a feed logger configured to serve a feed to the application interface of the user device.

7. The system of claim 1, wherein the system further comprises:
an interface to an external server for a third-party entity.

8. The system of claim 1, wherein the system is configured to serve the application a slot machine history of payout events for a slot machine profile.

9. The system of claim 1, wherein the:
the application includes an interface configured to enter an identification number for a slot machine;
and the system is configured to:
accept the slot machine identification from the application;
determine if a slot machine identification number from the application matches a slot machine profile for the slot machine; and
if so, serve the application a history of payout events for the slot machine profile, or
if not, prompt the user via the application to create the slot machine profile.

10. The system of claim 9, wherein:
the application interface configured to enter an identification number comprises a barcode scanner configured to operate a camera on the user device to scan a barcode of the slot machine.

11. The system of claim 9, wherein:
the application interface is configured to allow a user to manually enter an identification number of the slot machine.

12. The system of claim 1, wherein the application is configured to
track the time a user plays a given slot machine;
record the time the user played the slot machine; and
the system is configured to store the time the user played the slot machine to the slot machine profile for that machine.

13. The system of claim 12 wherein:
the application includes a movement tracker configured to interface with movement sensor data on the user device; and
when the movement tracker determines the user has moved while playing the machine, the application is configured to prompt the user to record slot machine event data for the slot machine profile.

14. A method being performed by a computer system that comprises one or more processors and a computer-readable storage medium encoded with instructions executable by at least one of the processors and operatively coupled to at least one of the processors, the method comprising:
serving an application an interface configured to allow a user to create a slot machine profile and input and display slot machine event data on a user device;
storing the slot machine profile in a slot machine database;
accepting slot machine event data for the slot machine profile, the slot machine event data including payout event data from the application; and
mapping the slot machine event data to the slot machine profile.

15. The computer-implemented method of claim 14, wherein the method further comprises:
storing a plurality of user profiles to a user profile database;
storing a plurality of slot machine profiles generated from a plurality of the user applications to a slot machine profile database; and
storing a plurality of casino profiles to a casino database.

16. The computer-implemented method of claim 15, wherein the method further comprises:
cross referencing, in one or more databases, the casino profiles, the user profiles, the slot machine profiles, and the connections between casino profiles, the user profiles, and the slot machine profiles.

17. The computer-implemented method of claim 14, wherein method further comprises:
serving the application a slot machine history of payout events for a slot machine profile.

18. The computer-implemented method of claim 17, wherein method further comprises:
accepting a slot machine identification from the application;
determining if a slot machine identification number from the application matches a slot machine profile for the slot machine; and
if so, serve the application the history of payout events for the slot machine profile, or
if not, prompt to create the slot machine profile via the application.

19. The computer-implemented method of claim 14, wherein method further comprises:
tracking, via the application, a time a user plays a given slot machine; and
storing the time the user played the slot machine to the slot machine profile for that machine.

20. The system of claim 19, wherein the method further comprises:
tracking, via a movement tracker on the user device, the movement of a user; and
determining, via the movement tracker, that the user has moved while playing the machine, and
prompting the user to record slot machine event data for the slot machine profile.
